(19) United States
(12) Patent Application Publication
(10) Pub. No.: US 2011/0039433 A1
(43) Pub. Date: Feb. 17, 2011

(54) PRODUCT STRUCTURE WITH EJECTOR

(76) Inventor: Horng Yu Tsai, SinJhuang City (TW)

Correspondence Address: PRO-TECHTOR INTERNATIONAL SERVICES, 20775 NORADA CT., SARATOGA, CA, 95070, US

(21) Appl. No.: 12/856,637

(22) Filed: Aug. 14, 2010

(30) Foreign Application Priority Data
Aug. 14, 2009 (TW) 098215078
Jan. 25, 2010 (TW) 099201498

(51) Int. Cl. H01R 13/62; F16B 1/00

(52) U.S. Cl. 439/159; 403/16

(57) ABSTRACT

A product structure includes a base and an ejector including a core, a sliding sheet, a guiding rod and an elastic member. The core has a sliding slot, which has a circulating path, one end formed with a positioning point, the other end formed with a starting point, and a bottom surface formed with unidirectional stopper blocks, so that the path unidirectionally circulates from the starting point sequentially to the positioning point and to the starting point. The sliding sheet having a pushing portion may slide back and forth relatively to the base. The rod has one end engaged with the slot and can slide along the path. The elastic member provides an elastic force for returning the sliding sheet, after being moved into the base, to a home position. The core has a seat and a metal baseplate, which is engaged with the seat and has the stopper blocks.

### BACKGROUND OF THE INVENTION

1. Field of the Invention

The invention relates to an ejector, and more particularly to a product structure with an ejector.

2. Related Art

In the mechanism design of the electronic product, an ejector capable of hiding the inserted member, such as a multimedia storage card or a memory card, and exposing the to-be-ejected member has been widely applied to the electronic products and the computer peripheral products. The currently available memory cards for the computer in the market have many specifications, such as those for the Secure Digital Card (SDC), the MutiMedia Card (MMC), the Smart Media Card (SMC), the Memory Stick Card (MSC), the XD-Picture Card (XDC), and the like. In addition, an Express card for the memory card is also developed.

The connector to be connected to the memory card has an ejector for hiding the inserted memory card and exposing the to-be-ejected card. As shown in FIGS. 1 and 2, a memory card connector with an ejector includes a base 10, terminals 25, a sliding sheet 20, a guiding rod 26 and a spring 28.

The base 10 is composed of a base 11 and an upper cover 19 covering the base 11. As shown in FIG. 3, the base 11 is made by way of plastic injection molding, and has many receiving slots 18 for receiving various specifications of memory cards. One side of the base 11 is integrally formed with a sliding slot 12. The sliding slot 12 has a heart-like shape, and has one end formed with a starting point 13, and the other end formed with a stroke point 14, a middle depressed positioning point 15 and a card-ejecting starting point 16. The sliding slot 12 is formed with many inclined blocks 17 so that the path unidirectionally circulates from the starting point 13 sequentially to the stroke point 14, to the positioning point 15, to the card-ejecting starting point 16 and to the starting point 13.

The terminals 25 are divided into many rows arranged on the base 11.

The sliding sheet 20 has an inverse-U shape, and has two sides resting against two sides of the receiving slot 18 of the base 11. One side of the sliding sheet 20 has a front end formed with a connection hole 21.

Two ends of the guiding rod 26 are formed with longitudinal hooking portions 27 for hooking the connection hole 21 of the sliding sheet 20 and the sliding slot 12 of the base 11, respectively.

The spring 28, disposed between the sliding sheet 20 and the rear end of the base 11, provides an elastic force for returning the sliding sheet 20 back to the home position after the sliding sheet 20 is moved into the base 10.

According to the above-mentioned structure, when the sliding sheet 20 is pushed by the inserted memory card, it drives the guiding rod 26 to slide in the sliding slot 12. Because the sliding slot 12 has the unidirectional circulation, the guiding rod 26 is pushed from the starting point 13 to the stroke point 14 and then pulled, by the elastic force of the spring, back to the positioning point 15 for positioning when the memory card is inserted. When the memory card is to be ejected, the memory card is also pushed, and the guiding rod 26 is pushed from the positioning point 15 to the card-ejecting starting point 16 and then pulled, by the elastic force of the spring, back to the starting point 13 so that the card can be inserted and ejected.

The conventional structure has the following drawbacks.

First, the sliding sheet 20 is not designed to engage with the base and slide relatively to the base. In order to make the sliding sheet 20 be stably assembled into the base, the sliding sheet 20 must be designed to have the inverse-U shape so that it can be stably placed on the base 11 and then positioned by the pressing of the upper cover. However, when the sliding sheet is designed to have the inverse-U shape, the used material becomes more, and the brittle plastic material tends to cause the crack.

Second, the sliding slot 12 is made by way of plastic injection molding. The plastic material has the poor structural strength. One end of the guiding rod 26 slides in the sliding slot 12 back and forth so that the sliding slot 12 tends to be worn after a long period of time.

In order to solve the above-mentioned drawbacks, the metal sheet may be integrally bent into the core or the metal sheet may be integrally bent into the sliding sheet and the core. However, the shape of the core is more complicated, and it is difficult to integrally bend the metal sheet into the core, and it is more difficult to integrally bend the metal sheet into the sliding sheet and the core.

### SUMMARY OF THE INVENTION

It is therefore an object of the invention to provide a product structure with an ejector, wherein a core of the ejector is composed of a seat and a metal baseplate so that the ejector may be easily manufactured and has the durability similar to the metal material.

The invention achieves the above-identified object by providing a product structure including a base and an ejector. The ejector includes a core, a sliding sheet, a guiding rod and an elastic member. The core has a sliding slot having a circulating path. The sliding slot has one end formed with a positioning point, the other end formed with a starting point, and a bottom surface formed with unidirectional stopper blocks, so that the circulating path unidirectionally circulates from the starting point sequentially to the positioning point and to the starting point. The sliding sheet may slide back and forth relatively to the base and has a pushing portion. The guiding rod has one end engaged with the sliding slot of the core and can slide along the circulating path. The elastic member provides an elastic force for returning the sliding sheet to a home position after the sliding sheet is moved into the base. The core has a seat and a metal baseplate, which is engaged with the seat and has the unidirectional stopper blocks.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a pictorially exploded view showing a conventional electrical connector.

FIG. 2 is a pictorially assembled view with the conventional electrical connector without an upper cover.

FIG. 3 is a pictorial view showing a sliding slot of the conventional electrical connector.

FIG. 4 is a pictorially exploded view showing a first embodiment of the invention.

FIG. 5 is a pictorially assembled view showing the first embodiment of the invention.

FIG. 6 is a pictorially assembled view showing the first embodiment of the invention without an upper cover.

FIG. 7 is a pictorial view showing a metal baseplate of the first embodiment of the invention.

FIG. 8 is a pictorial view showing a core according to the first embodiment of the invention.

FIG. 9 is a top view showing the core of the first embodiment of the invention.

FIG. 10 is a pictorial view showing a used state of the first embodiment of the invention.

FIG. 11 is a pictorial view showing the used state of the first embodiment of the invention.

FIG. 12 is a pictorial view showing the used state of the first embodiment of the invention.

FIG. 13 is a pictorially exploded view showing a core according to a second embodiment of the invention.

FIG. 14 is a pictorially assembled view showing the core according to the second embodiment of the invention.

FIG. 15 is a pictorially exploded view showing a third embodiment of the invention.

FIG. 16 is a pictorially assembled view showing the third embodiment of the invention without an upper cover.

FIG. 17 shows a used state of the third embodiment of the invention.

FIG. 18 is a pictorially exploded view showing a core of a fourth embodiment of the invention.

FIG. 19 is a pictorial view showing the core of the fourth embodiment of the invention.

FIG. 20 is a top view showing the core of the fourth embodiment of the invention.

FIG. 21 is a pictorially exploded view showing a core of a fifth embodiment of the invention.

FIG. 22 is a pictorial view showing the core of the fifth embodiment of the invention.

FIG. 23 is a pictorially exploded view showing a core of a sixth embodiment of the invention.

FIG. 24 is a pictorial view showing the core of the sixth embodiment of the invention.

FIG. 25 is a top view showing the core of the sixth embodiment of the invention.

FIG. 26 is an assembled view showing the core of the sixth embodiment of the invention.

FIG. 27 is a pictorially exploded view showing a core of a seventh embodiment of the invention.

FIG. 28 is a pictorially exploded view showing a core of an eighth embodiment of the invention.

FIG. 29 is a pictorially exploded view showing a core of a ninth embodiment of the invention.

FIG. 30 is another pictorially exploded view showing the core of the ninth embodiment of the invention.

FIG. 31 is a pictorially exploded view showing a core of a tenth embodiment of the invention.

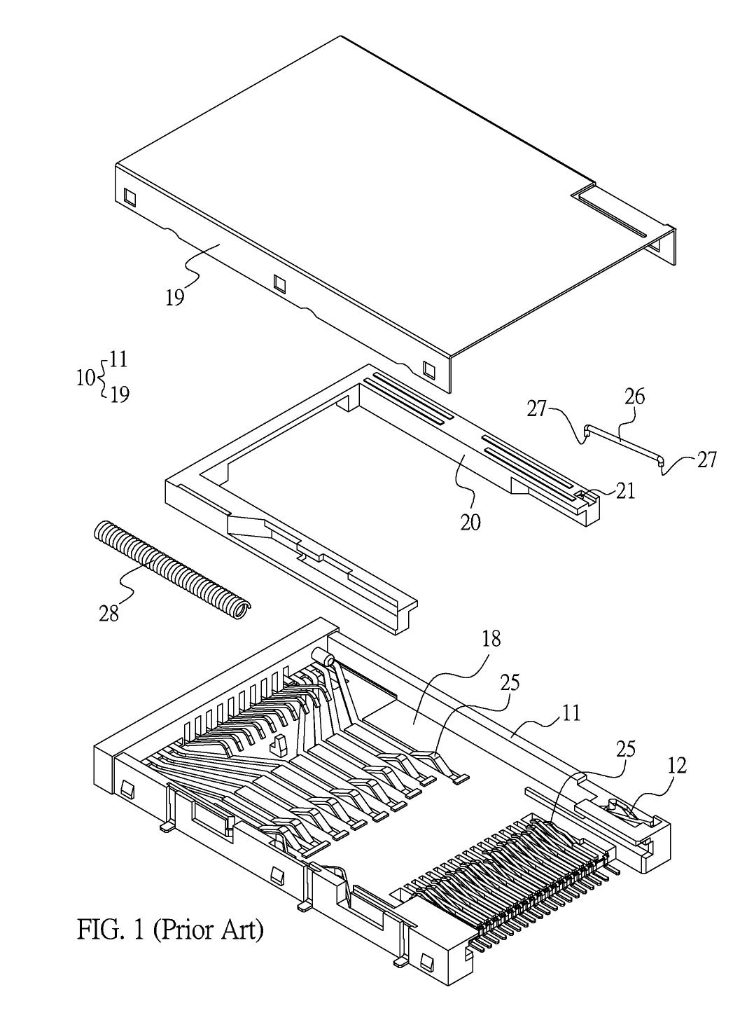

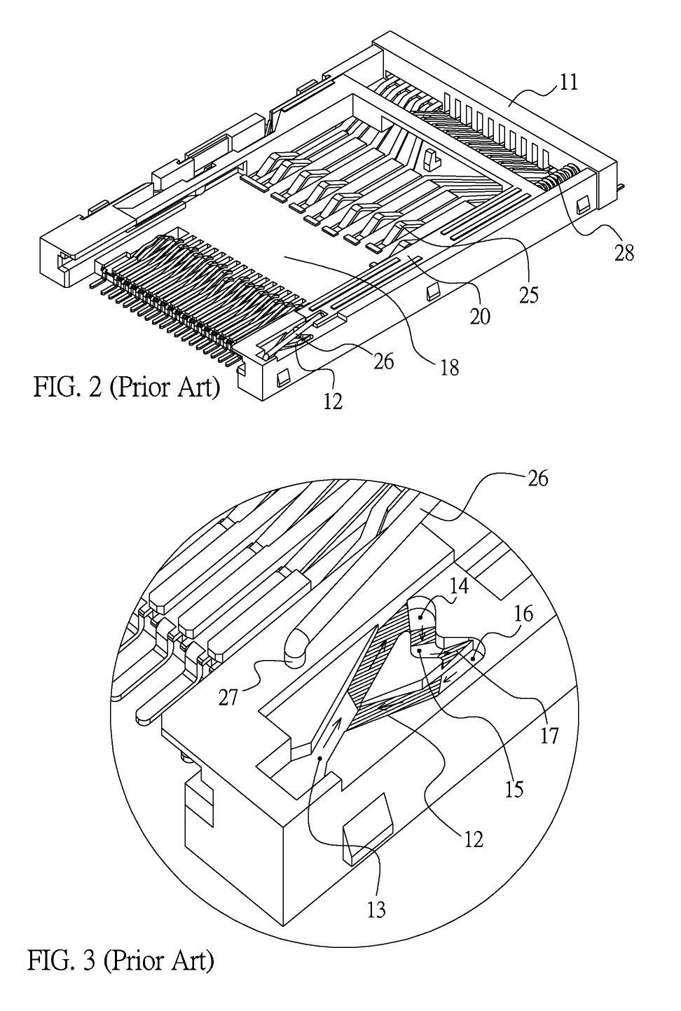

### DETAILED DESCRIPTION OF THE INVENTION

The present invention will be apparent from the following detailed description, which proceeds with reference to the accompanying drawings, wherein the same references relate to the same elements.

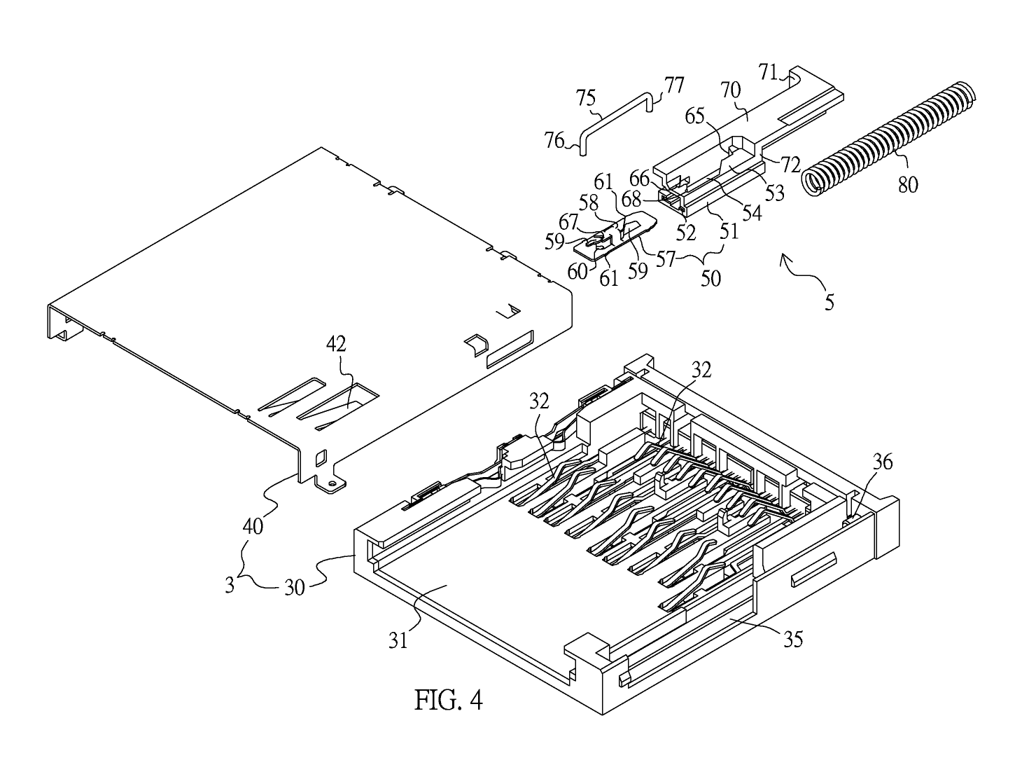

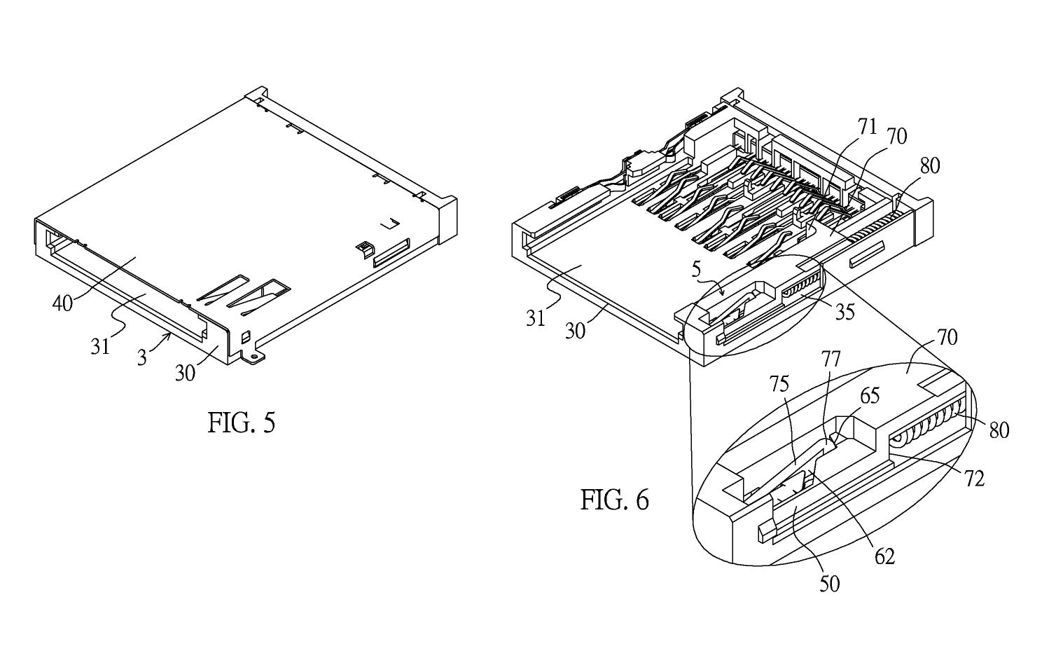

Referring to FIGS. 4 to 6, a memory card connector capable of receiving multiple cards with different specifications according to the first embodiment of the invention includes a base 3 and an ejector 5.

The base 3 has a plastic base 30 and a metal upper cover 40. The metal upper cover 40 covers the plastic base 30 to form a connection slot 31 between the metal upper cover 40 and the plastic base 30. An elastic sheet 42 protruding inwardly is formed on one side of the metal upper cover 40 by way of pressing. Two rows of terminals 32 are disposed on the plastic base 30. One side of the plastic base 30 is formed with a slide slot 35. One end of the slide slot 35 is formed with a protruding rod 36.

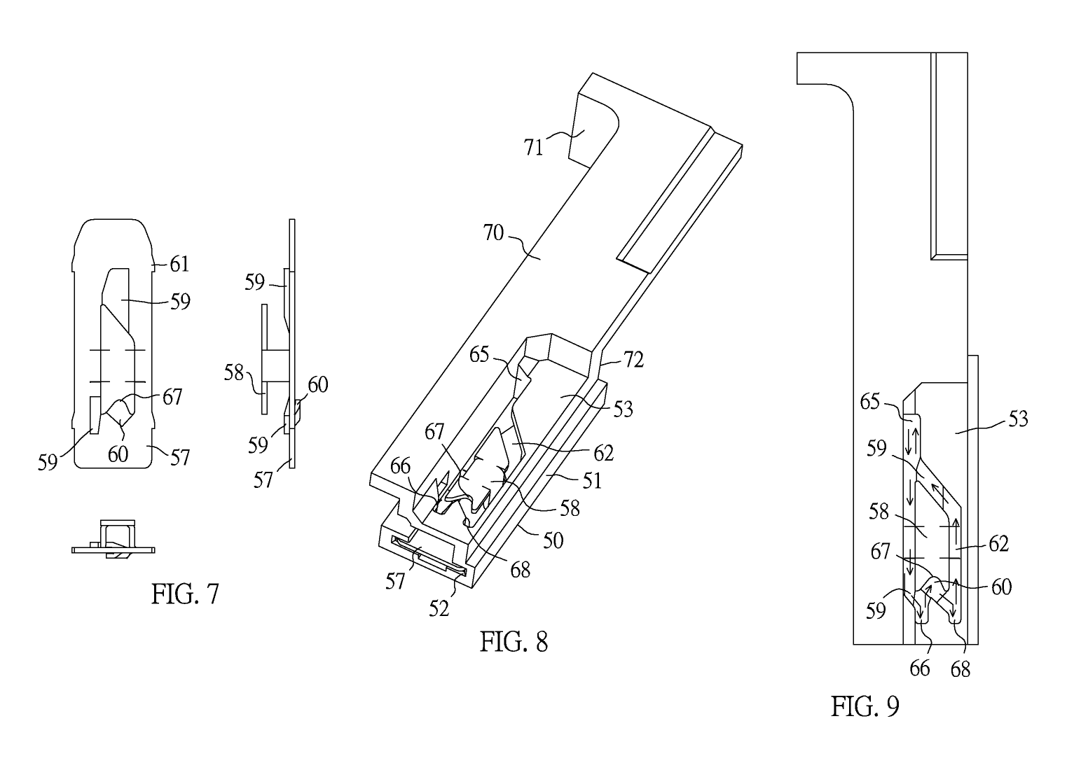

Referring to FIGS. 7 to 9, the ejector 5 includes a core 50, a sliding sheet 70, a guiding rod 75 and a spring 80.

The core 50 is disposed in the slide slot 35 of the plastic base 30 and has a seat 51 and a metal baseplate 57. The seat 51 is made of a plastic material by way of injection molding and has an outer track plate 53 and a slot 52. The outer track plate 53 has an opening 54 and is disposed above the slot 52. The opening 54 has one end, which is a tip end and defined as a starting point 65, and the other end, which has an M-like shape to form a middle projection and two concave portions. The two concave portions are respectively formed with a stroke point 66 and a card-ejecting starting point 68. The middle of the metal baseplate 57 is formed with an inner track plate 58 projecting beyond the plate surface of the metal baseplate 57, and the periphery of the metal baseplate 57 is formed with three unidirectional stopper blocks 59 and 60 each having a height difference with respect to the plate surface, wherein two unidirectional stopper blocks 59 project beyond the plate surface, and one unidirectional stopper block 60 sinks into the plate surface. The periphery of the metal baseplate 57 is symmetrically formed with four projecting pressing portions 61. The metal baseplate 57 engages with the slot 52 of the seat 51. The pressing portion 61 tightly presses against the slot 52 so that the inner track plate 58 is disposed in the opening 54. A sliding slot 62 is formed between the inner and outer track plates. The sliding slot 62 defines a circulating path. One end of the inner track plate 58 corresponding to one end of the M-shaped structure of the outer track plate 53 is also formed with an M-like shape to form a depressed positioning point 67. The other end of the inner track plate 58 is a tip end corresponding to the starting point 65. The sliding slot 62 presses the guiding rod 75 through the three unidirectional stopper blocks 59 and 60 and the elastic sheet 42 of the upper cover so that the circulating path unidirectionally circulates from the starting point 65 sequentially to the stroke point 66, to the positioning point 67, to the card-ejecting starting point 68 and to the starting point 65.

The sliding sheet 70 and the seat 51 of the core 50 are integrally made of the plastic material by way of injection molding. The sliding sheet 70 substantially has an inverse-L shape and has a pushing portion 71 and a resting portion 72. The pushing portion 71 is disposed on one end of the sliding sheet 70 and projects into the plastic base 30 so that it can be pressed by the inserted memory card.

The guiding rod 75 has an inverse-U shape and has one end 76 for hooking and positioning the plastic base 30, and the other end 77 fit with the sliding slot 62 of the core 50. When the sliding sheet 70 is pushed, the core 50 is driven to make the other end 77 of the guiding rod 75 slide in the sliding slot 62.

The spring 80, disposed in the slide slot 35 of the plastic base 30, has one end fit with the protruding rod 36, and the other end pressing against the resting portion 72 of the sliding sheet 70, and provides the elastic force for returning the sliding sheet 70 to the home position after the sliding sheet 70 moves into the base.

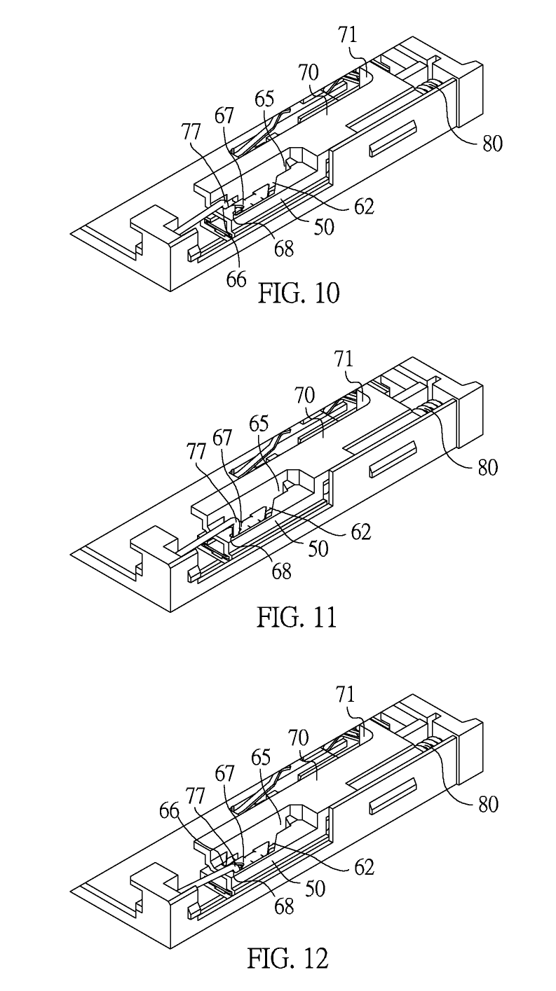

According to the above-mentioned structure, as shown in FIGS. 6 and 9, when the memory card has not yet been inserted into the connection slot 31, the sliding sheet 70 is not pushed. At this time, the end 77 of the guiding rod is located at the starting point 65 of the sliding slot 62 of the core 50. When the memory card is inserted into the connection slot, it touches the pushing portion 71 of the sliding sheet 70 to push the sliding sheet 70 together with the core 50 to slide backwards. As shown in FIG. 10, when the memory card is completely inserted, the end 77 of the guiding rod is located at the stroke point 66 of the sliding slot 62. As shown in FIG. 11, when the user relinquishes his/her hold on the card, the sliding sheet 70 is ejected due to the elastic force of the spring 80. At this time, the end 77 of the guiding rod is moved along the unidirectional circulating path of the sliding slot 62 and located at the positioning point 67. At this time, the sliding sheet 70 is in the positioning state, and the memory card is in the inserted state. As shown in FIG. 12, when the card is to be ejected, the memory card is pressed backwards. At this time, the end 77 of the guiding rod is moved along the unidirectional circulating path of the sliding slot 62 and located at the card-ejecting starting point 68. When the user again relinquishes his/her hold on the card, the sliding sheet 70 is ejected due to the elastic force of the spring 80. At this time, the end 77 of the guiding rod is moved along the unidirectional circulating path of the sliding slot 62 and then goes back to the starting point 65. As shown in FIGS. 6 and 9, the sliding sheet 70 returns to the start position, and the memory card is in the ejected state.

According to the above-mentioned descriptions, the invention has the following advantages.

First, the sliding sheet 70 and the seat 51 of the core are integrally made of the plastic material by way of injection molding so that the simplicity in manufacturing may be obtained.

The wear-resistant bottom surface and the inner track plate are made of a metal baseplate so that the long lifetime is obtained. In addition, the metal baseplate is simply pressed to form multiple unidirectional stopper blocks and one inner track plate. Thus, the pressing process is simpler than that of pressing the sliding sheet and the core, which are integrally formed.

Third, the sliding sheet 70 and the core 50 are combined together so that the structure can be simplified, and the overall structure may slide on the plastic base more stably.

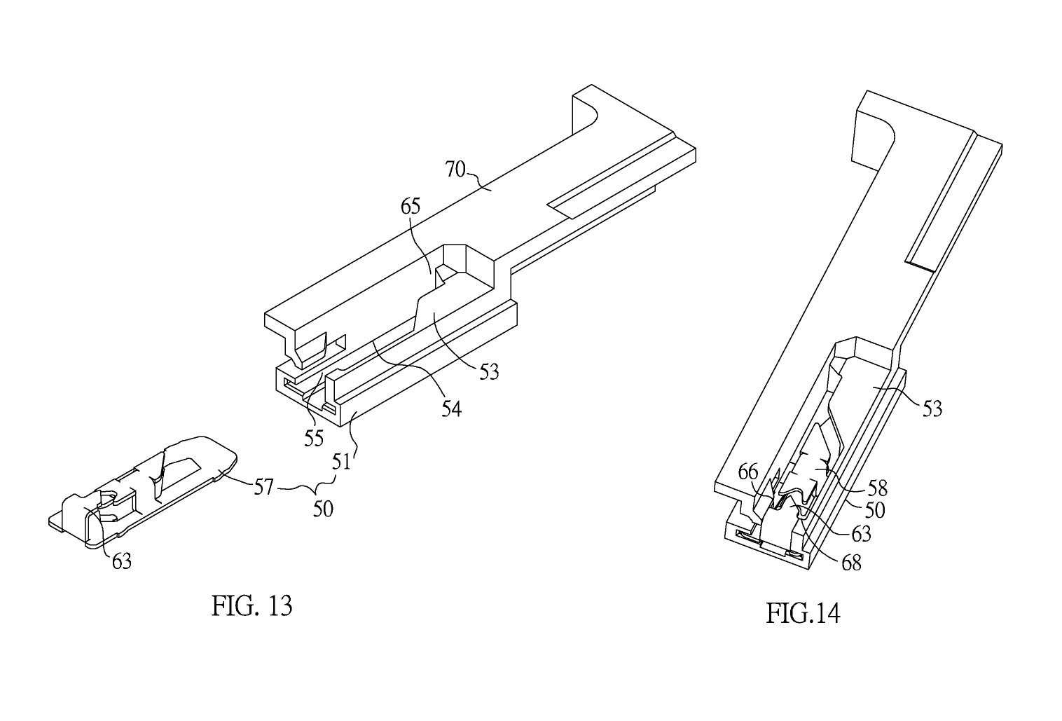

As shown in FIGS. 13 and 14, the second embodiment of the invention is almost the same as the first embodiment except that the other end of the opening 54 of the outer track plate 53 of the seat 51 of the core 50 corresponding to the starting point 65 is an open end 55, and that one end of the metal baseplate 57 is bent to form a projecting plate 63, which is flush with the outer track plate and projects beyond the plate surface. The projecting plate 63 fills the open end 55 of the opening of the outer track plate so that the end is formed with a middle projection and two concave portions. The two concave portions are respectively the stroke point 66 and the card-ejecting starting point 68. Because the projecting plate 63 is considerably worn when being used, the projecting plate 63 formed by the metal baseplate 57 in this embodiment further enhances the durability.

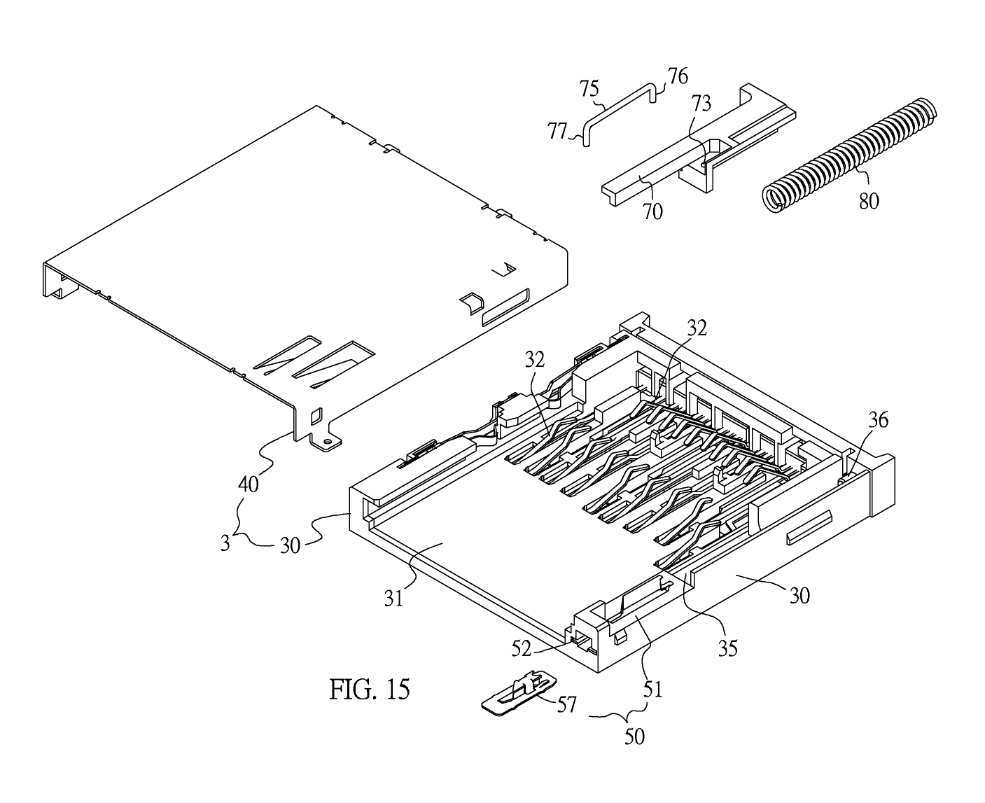

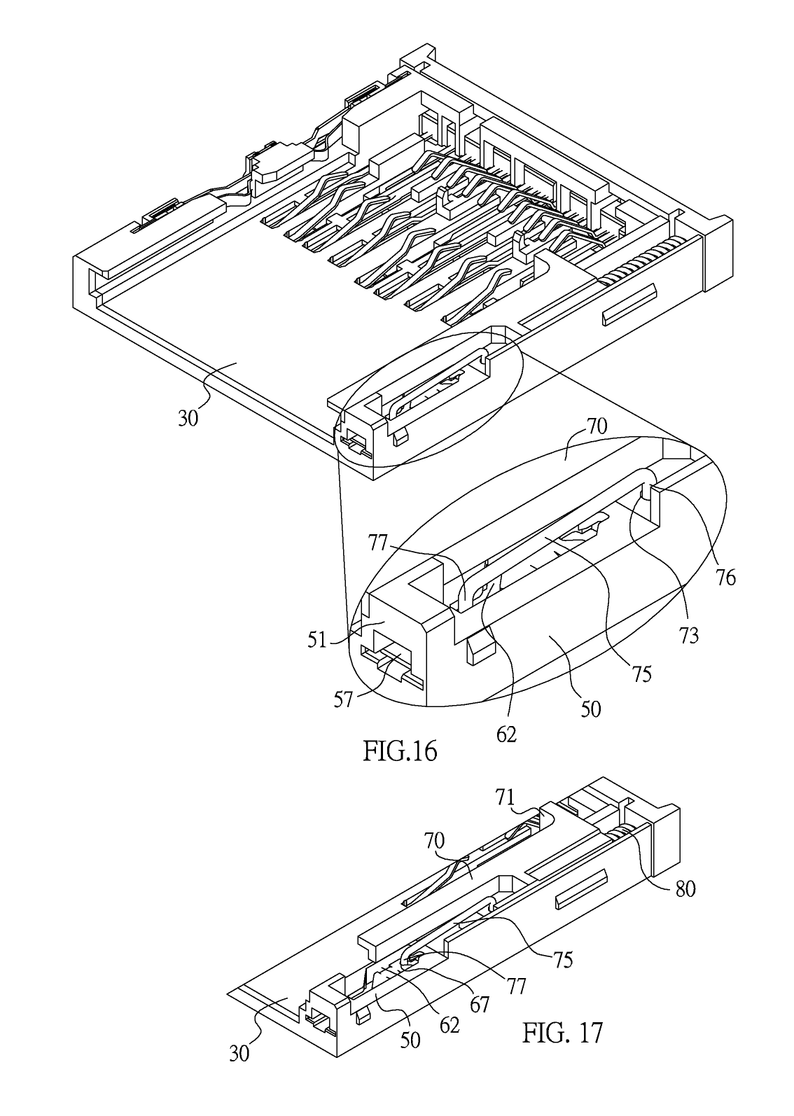

As shown in FIGS. 15 and 16, the third embodiment is almost the same as the first embodiment except that the seat 51 of the core 50 and the plastic base 30 of the base 3 are integrally formed by way of injection molding. Similarly, the metal baseplate 57 is mounted in the slot 52 of the seat 51, the end 76 of the guiding rod 75 is engaged with a fixing hole 73 of the sliding sheet 70, and the other end 77 of the guiding rod 75 is fit with the sliding slot 62 of the core 50.

As shown in FIG. 17, when the memory card is inserted into the connection slot, it touches the pushing portion 71 of the sliding sheet 70 to push the sliding sheet 70 to slide backwards. The end 77 of the guiding rod slides along the sliding slot 62. When the end 77 of the guiding rod is located at the positioning point 67, the sliding sheet 70 is in the positioning state, and the memory card is in the inserted state.

In the first embodiment, the sliding sheet and the seat of the core are integrally formed by way of injection molding. In the third embodiment, the plastic base and the seat of the core are integrally formed by way of injection molding. However, the seat of the core, which is individually formed by way of plastic injection molding or metal casting, is also deemed as falling within the scope of the invention.

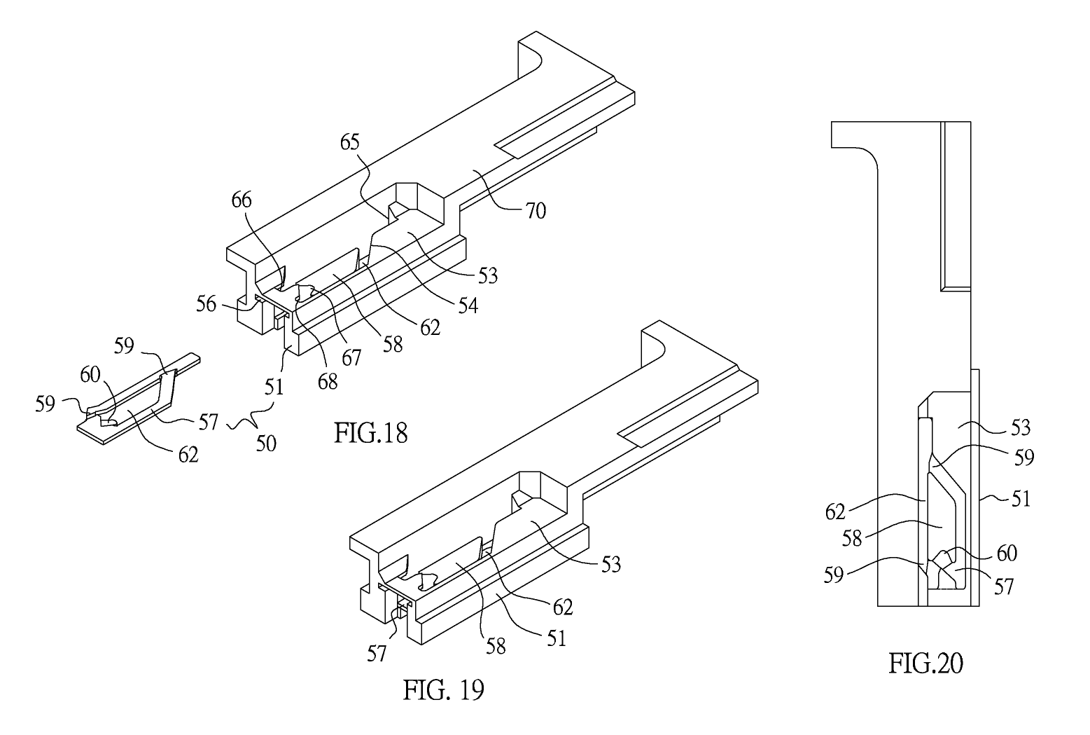

As shown in FIGS. 18 to 20, the fourth embodiment of the invention is almost the same as the first embodiment except for the core. The core 50 of this embodiment is also disposed in the slide slot of the plastic base and has a seat 51 and a metal baseplate 57.

The seat 51 and the sliding sheet 70 are also integrally formed by way of plastic injection molding and has one outer track plate 53 and one inner track plate 58. The outer track plate 53 has an opening 54. The opening 54 has one end being a tip end defined as the starting point 65, and the other end having an M-like shape to form a middle projection and two concave portions. The two concave portions are respectively the stroke point 66 and the card-ejecting starting point 68. The inner track plate is disposed in the opening 54. A sliding slot 62 is formed between the inner and outer track plates. The sliding slot 62 has a circulating path. One end of the inner track plate 58 corresponding to the end of the M-like shape of the outer track plate 53 also has an M-like shape to form a depressed positioning point 67. The other end of the inner track plate 58 is a tip end corresponding to the starting point 65. In addition, the upper section of the front end of the seat 51 is formed with a fitting hole 56.

The middle of the metal baseplate 57 is formed with an opening 612 corresponding to the inner track plate 58, and the periphery of the metal baseplate 57 is formed with three unidirectional stopper blocks 59 and 60 each having a height difference with respect to the plate surface, wherein two unidirectional stopper blocks 59 project beyond the plate surface, and one unidirectional stopper block 60 sinks into the plate surface. The metal baseplate 57 is inserted into the seat 51 from the fitting hole 56 of the seat 51. The metal baseplate 57 is pressed down after the opening 612 is aligned with the inner track plate 58, and the metal baseplate 57 is located on the bottom surface of the sliding slot 62. The sliding slot 62 presses the guiding rod through the three unidirectional stopper blocks 59 and 60 and the elastic sheet of the upper cover, such that the circulation path unidirectionally circulates from the starting point 65 sequentially to the stroke point 66, to the positioning point 67, to the card-ejecting starting point 68 and to the starting point 65.

The inner track plate 58 of this embodiment and the seat are directly injection molded, and only three unidirectional stopper blocks 59 and 60 are pressed on the metal baseplate 57. Thus, the manufacturing processes are simpler than those of the first embodiment. Because the three unidirectional stopper blocks 59 and 60 tend to be worn more easily, this embodiment has the effect of the long lifetime, and provides the simpler manufacturing processes.

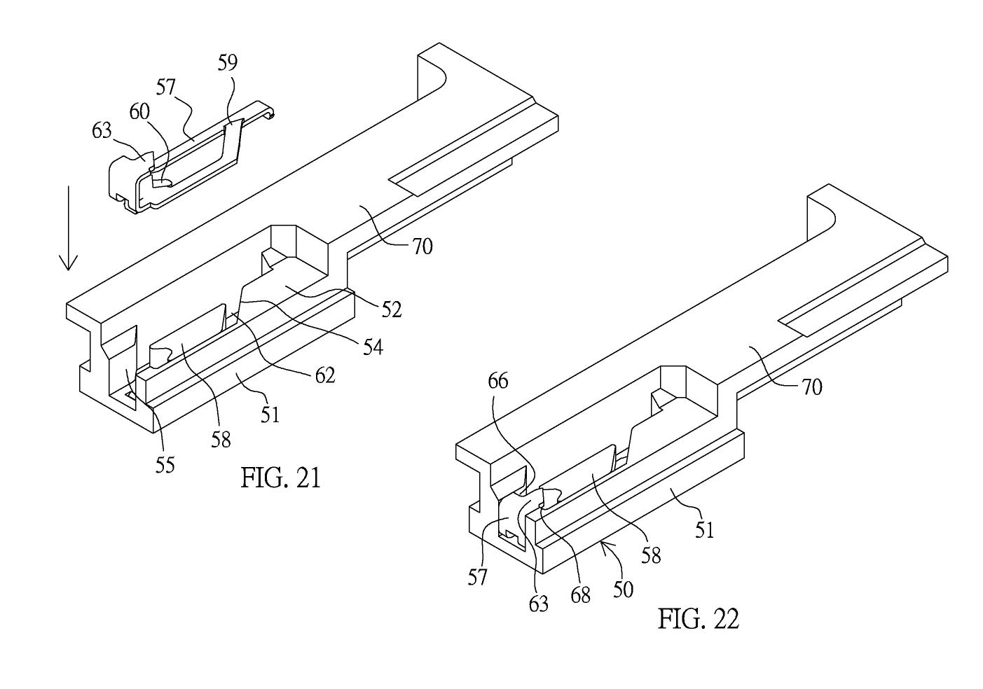

As shown in FIGS. 21 and 22, the fifth embodiment of the invention is almost the same as the fourth embodiment except that the other end of the opening 54 of the outer track plate 53 of the seat 51 of this embodiment corresponding to the starting point 65 is an open end 55, and that one end of the metal baseplate 57 is bent to form a projecting plate 63, which is flush with the outer track plate and projects beyond the plate surface. The projecting plate 63 fills the open end 55 of the opening of the outer track plate so that the end is formed with a middle projection and two concave portions. The two concave portions are respectively formed with a stroke point 66 and a card-ejecting starting point 68. The projecting plate 63 being used is considerably worn, so the projecting plate 63 formed by the metal baseplate 57 in this embodiment can further enhance the durability.

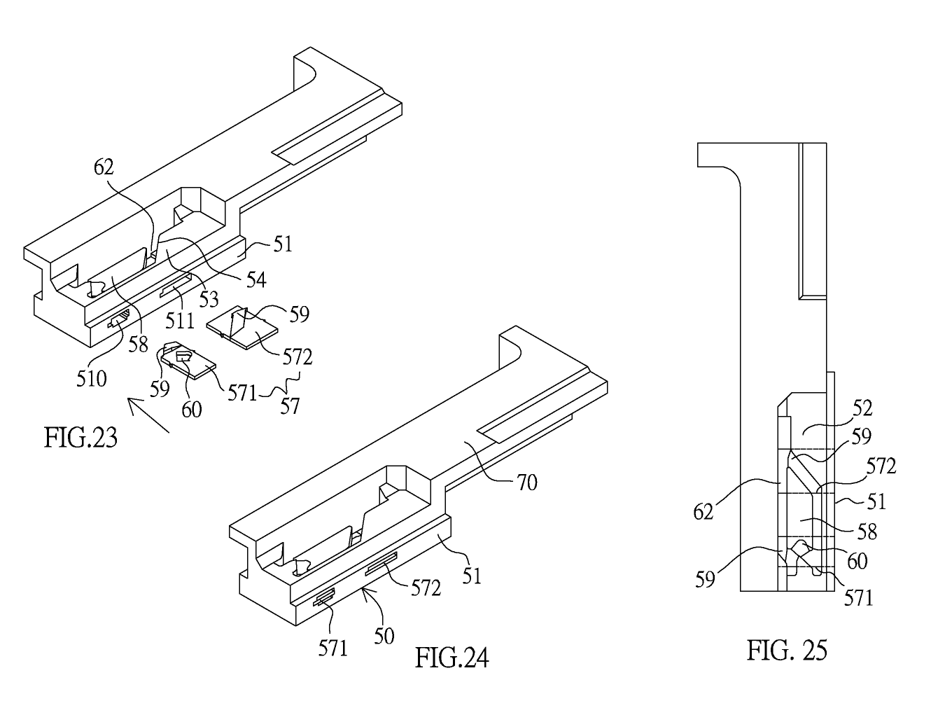

As shown in FIGS. 23 to 25, the sixth embodiment of the invention is almost the same as the fourth embodiment except that one side of the seat 51 of this embodiment is formed with slots 510 and 511. The metal baseplate 57 includes a first plate 571 and a second plate 572. The first plate 571 has a projecting unidirectional stopper block 59 and a depressed unidirectional stopper block 60. The second plate 572 has a projecting unidirectional stopper block 59, and the first plate 571 and the second plate 572 are respectively engaged with the slots 510 and 511 for positioning, such that the two projecting unidirectional stopper blocks 59 and the depressed unidirectional stopper block 60 are disposed on the bottom surface of the sliding slot 62.

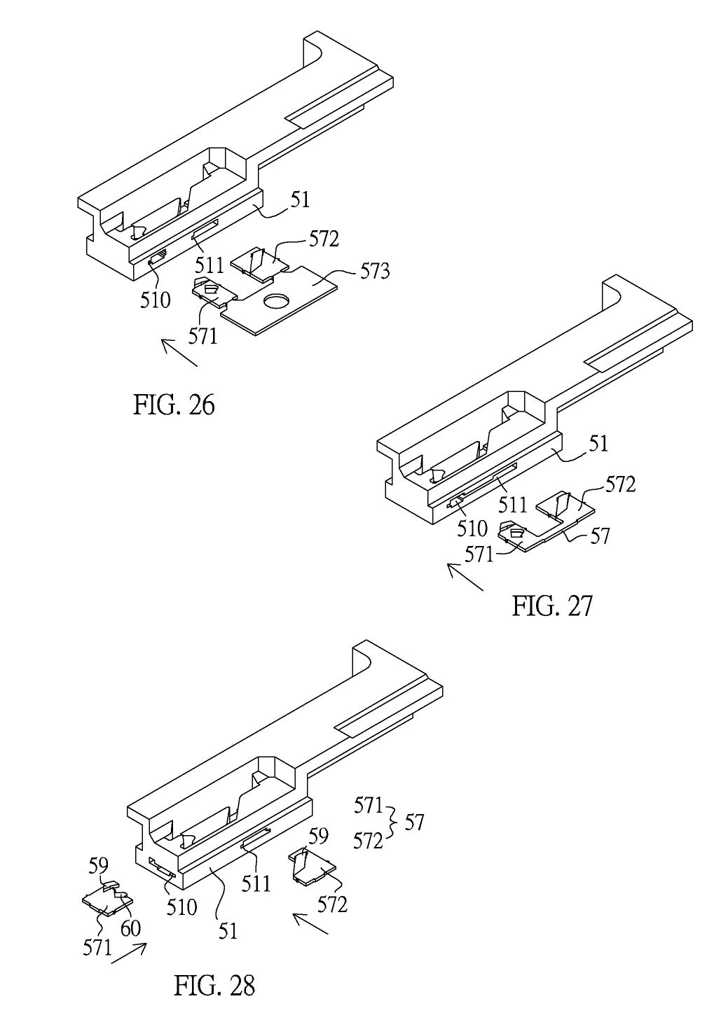

As shown in FIG. 26, the first plate 571 and the second plate 572 formed by way of pressing may be connected to a material tape 573 so that they can be assembled into the seat 51 and then the material tape can be separated from the first plate 571 and the second plate 572.

As shown in FIG. 27, the seventh embodiment of the invention is almost the same as the sixth embodiment except that the first plate 571 and the second plate 572 of the seventh embodiment are integrally connected together so that they can be simultaneously assembled into the seat 51.

As shown in FIG. 28, the eighth embodiment of the invention is almost the same as the seventh embodiment except that the front end of the seat 51 of the eighth embodiment has a slot 510 and one side of the seat 51 is formed with a slot 511. The metal baseplate 57 also includes a first plate 571 and a second plate 572. The first plate 571 has a projecting unidirectional stopper block 59 and a depressed unidirectional stopper block 60. The second plate 572 has a projecting unidirectional stopper block 59. The first plate 571 and the second plate 572 are respectively engaged with the slots 510 and 511 for positioning, such that the two projecting unidirectional stopper blocks 59 and the depressed unidirectional stopper block 60 are disposed on the bottom surface of the sliding slot 62.

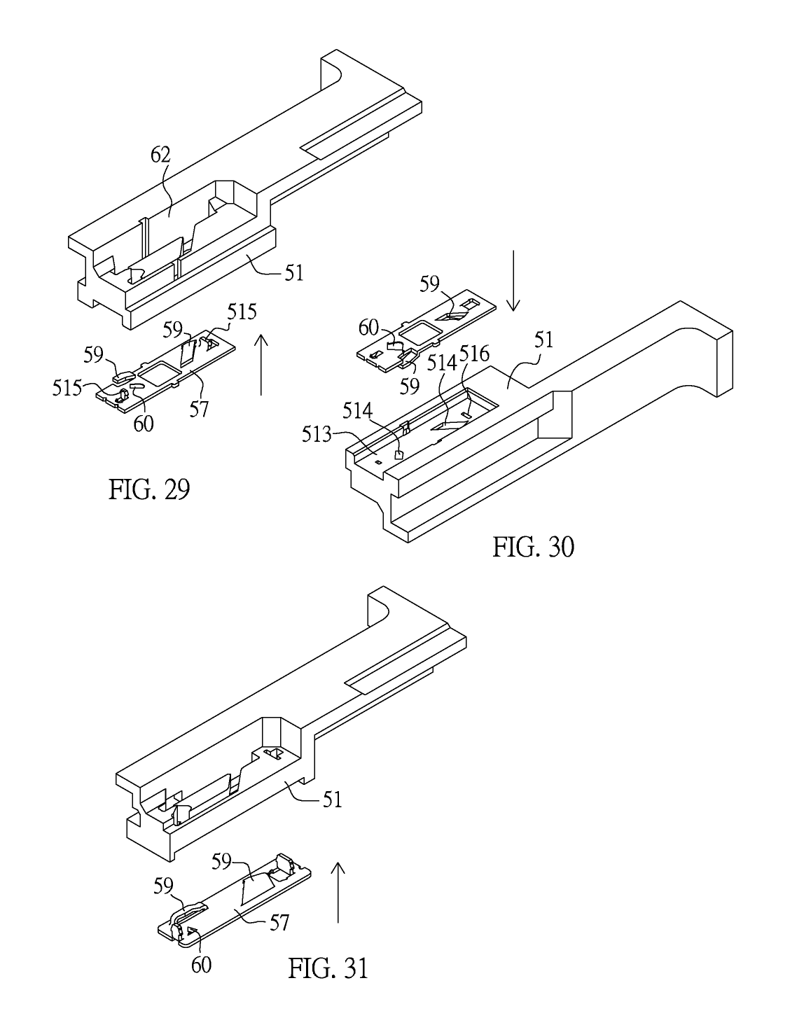

As shown in FIGS. 29 and 30, the ninth embodiment of the invention is almost the same as the fourth embodiment except that the bottom surface of the seat 51 of the ninth embodiment has a positioning slot 513. The positioning slot 513 has two engagement holes 516 and several through holes 514 communicating with the sliding slot 62. The metal baseplate 57 is mounted on the positioning slot 513 of the seat 51. The metal baseplate 57 has an engaging sheet 515 to be engaged with an engagement hole 516 of the seat 51, and the unidirectional stopper blocks 59 and 60 on the metal baseplate 57 pass through the through holes 514 and reach the bottom surface of the sliding slot 62.

As shown in FIG. 31, the tenth embodiment of the invention is almost the same as the ninth embodiment. In the tenth embodiment, the metal baseplate 57 is mounted on the bottom surface of the seat 51.

In the above-mentioned embodiments, multiple cards may share the memory card connector. However, the structure of the invention may also be applied to the Express card connector or any other product with the ejector. Any product adopting the characteristic of the invention is still deemed as falling within the scope of the invention.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A product structure, comprising:
a base; and
an ejector comprising:
a core having a sliding slot, wherein the sliding slot has a circulating path, one end of the sliding slot has a positioning point, the other end of the sliding slot has a starting point, and a bottom surface of the sliding slot is formed with unidirectional stopper blocks, so that the circulating path circulates from the starting point sequentially to the positioning point and then back to the starting point;
a sliding sheet, which may slide back and forth relatively to the base and has a pushing portion;
a guiding rod having one end engaged with the sliding slot of the core and capable of sliding along the circulating path; and
an elastic member for providing an elastic force for returning the sliding sheet to a home position after the sliding sheet is moved into the base;
wherein the core has a seat and a metal baseplate, which is engaged with the seat and has the unidirectional stopper blocks.

2. The product structure according to claim 1, wherein the product structure is an electrical connector, a connection slot is formed in the base, and at least one row of terminals are disposed in the base.

3. The product structure according to claim 2, wherein the base comprises a plastic base and an upper cover covering the plastic base.

4. The product structure according to claim 3, wherein one side of the plastic base has an assembling slot, the ejector is assembled into the assembling slot, the sliding sheet has a resting portion, and the elastic member has one end positioned in the base and the other end resting against the resting portion.

5. The product structure according to claim 1, wherein the seat has an outer track plate and a slot, the outer track plate has an opening, a middle of the metal baseplate is formed with an inner track plate projecting beyond a plate surface of the metal baseplate, the metal baseplate is engaged with the slot of the seat, the inner track plate is disposed in the opening, the sliding slot is formed between the inner and outer track plates, one end of the inner track plate is depressed to form the positioning point, and one end of the opening of the outer track plate corresponding to the other end of the inner track plate is formed with the starting point.

6. The product structure according to claim 1, wherein the seat of the core and the sliding sheet are integrally made of a plastic material.

7. The product structure according to claim 1, wherein the seat of the core and the base are integrally formed.

8. The product structure according to claim 1, wherein the seat has an outer track plate, the outer track plate has an opening, the opening is formed with an inner track plate, the sliding slot is formed between the inner and outer track plates, one end of the inner track plate is depressed to form the positioning point, and one end of the opening of the outer track plate corresponding to the other end of the inner track plate is formed with the starting point.

9. The product structure according to claim 5, wherein one end of the inner track plate formed with the positioning point has an M-like shape, the other end of the opening of the outer track plate also has the M-like shape corresponding to one end of the M-like shape of the inner track plate so that the end is formed with one middle projection and two concave portions, the two concave portions are respectively formed with a stroke point and a card-ejecting starting point, and the circulating path unidirectionally circulates from the starting point sequentially to the stroke point, to the positioning point, to the card-ejecting starting point and to the starting point.

10. The product structure according to claim 5, wherein the other end of the opening of the outer track plate is an open end, one end of the metal baseplate is bent to form a projecting plate projecting beyond a plate surface of the metal baseplate, the projecting plate fills the open end of the opening of the outer track plate so that the end is formed with a middle projection and two concave portions, the two concave portions are respectively formed with a stroke point and a card-ejecting starting point, and the circulating path unidirectionally circulates from the starting point sequentially to the stroke point, to the positioning point, to the card-ejecting starting point and to the starting point.

11. The product structure according to claim 5, wherein a front end of the seat is formed with a fitting hole, the middle of the metal baseplate has an opening corresponding to the inner track plate, and the metal baseplate is inserted into the seat from the fitting hole of the seat and disposed on the bottom surface of the sliding slot.

12. The product structure according to claim 8, wherein one side of the seat has a slot, and the metal baseplate is assembled into and engaged with the slot from the one side of the seat.

13. The product structure according to claim 8, wherein each of a front end and one side of the seat is formed with a slot, the metal baseplate comprises a first plate and a second plate, the first plate and the second plate are assembled into and engaged with the slots from the front end and the one side of the seat, respectively.

14. The product structure according to claim 8, wherein the metal baseplate is mounted on a bottom surface of the seat.

15. The product structure according to claim 8, wherein one end of the inner track plate formed with the positioning point has an M-like shape, the other end of the opening of the outer track plate also has the M-like shape corresponding to one end of the M-like shape of the inner track plate so that the end is formed with one middle projection and two concave portions, the two concave portions are respectively formed with a stroke point and a card-ejecting starting point, and the circulating path unidirectionally circulates from the starting point sequentially to the stroke point, to the positioning point, to the card-ejecting starting point and to the starting point.

16. The product structure according to claim 8, wherein the other end of the opening of the outer track plate is an open end, one end of the metal baseplate is bent to form a projecting plate projecting beyond a plate surface of the metal baseplate, the projecting plate fills the open end of the opening of the outer track plate so that the end is formed with a middle projection and two concave portions, the two concave portions are respectively formed with a stroke point and a card-ejecting starting point, and the circulating path unidirectionally circulates from the starting point sequentially to the stroke point, to the positioning point, to the card-ejecting starting point and to the starting point.
